(19) United States
(12) Patent Application Publication
(10) Pub. No.: US 2009/0239781 A1
(43) Pub. Date: Sep. 24, 2009

(54) Detergent Composition Comprising a Co-Polyester of Dicarboxylic Acids and Diols

(76) Inventors: Laura Judith Smalley, Newcastle upon Tyne (GB); Timothy Jobson, Tyne & Wear (GB)

Correspondence Address: THE PROCTER & GAMBLE COMPANY;Global Legal Department - IP, Sycamore Building - 4th Floor, 299 East Sixth Street, CINCINNATI, OH, 45202, US

(21) Appl. No.: 12/405,264

(22) Filed: Mar. 17, 2009

(30) Foreign Application Priority Data
Mar. 18, 2008 (EP) 08152950.5

(51) Int. Cl. C11D 3/34

(52) U.S. Cl. 510/357

(57) ABSTRACT

The present invention relates to a solid particulate laundry detergent composition comprising: (a) 0.1 wt % to 20 wt % detersive surfactant, wherein the surfactant comprises: (i) alkyl benzene sulphonate; and (ii) one or more detersive co-surfactants; (b) a co-polyester of dicarboxylic acids and diols; (c) polymeric carboxylate; (d) bleach; and (e) cellulosic polymer; wherein the composition comprises a spray-dried particle comprising at least some of the alkyl benzene sulphonate and at least some of the polymeric carboxylate, wherein the weight ratio of alkyl benzene sulphonate to repel-o-tex present in the composition is in the range of from 20:1 to 100:1, and wherein the weight ratio of detersive co-surfactant to repel-o-tex present in the composition is in the range of from 5:1 to 60:1.

### FIELD OF THE INVENTION

The present invention relates to highly water-soluble solid laundry detergent compositions. The compositions of the present invention comprise a co-polyester of dicarboxylic acids and diols. When incorporated in the compositions of the present invention, these co-polyesters provides single-cycle, multi-fabric type soil release benefits, as opposed to the multi-cycle polyester soil release benefit they are known to provide.

### BACKGROUND OF THE INVENTION

Polyester soil release polymers, such as co-polyesters of dicarboxylic acids and diols, are incorporated into solid laundry detergent compositions to improve their soil release performance. However, the performance benefit of polyester soil release polymers is limited only to polyester fabrics, and is only observable by the consumer after multiple washing cycles.

The inventors have surprisingly found that incorporating co-polyesters of dicarboxylic acids and diols into a specific laundry detergent composition, a soil release performance is observed on multiple fabric types, including cotton and polyester fabrics, and even more surprisingly, this multi-fabric type soil release performance benefit is observable after a single washing cycle.

### SUMMARY OF THE INVENTION

The present invention provides a solid laundry detergent composition as defined by claim 1.

### DETAILED DESCRIPTION OF THE INVENTION

Solid laundry detergent composition: The composition is in solid form, preferably solid particulate form. The composition is typically in free-flowing particulate form. The composition can be in any free-flowing particulate form, such as in the form of an agglomerate, a spray-dried power, an extrudate, a flake, a needle, a noodle, a bead, or any combination thereof.

The composition may be made by any suitable method including agglomeration, spray-drying, extrusion, mixing, dry-mixing, liquid spray-on, roller compaction, spheronisation or any combination thereof.

The composition may even be in unit dose form, such as in the form of a tablet (e.g. when particulates are tabletted to form a tablet), or in the form of a pouch, being at least partially, preferably essentially completely enclosed by a water-soluble film, such as a film that comprises polyvinyl alcohol.

The composition comprises a co-polyester of dicarboxylic acids and diols. These co-polyesters improve the soil release performance of the composition. The co-polyester of dicarboxylic acids and diols provides single cycle, multi-fabric type soil release performance benefits when incorporated in the composition of the present invention. The co-polyester of dicarboxylic acids and diols is described in more detail below.

The composition comprises a detersive surfactant. The detersive surfactant is described in more detail below but typically comprises: (a) C₁₀-C₁₃ alkyl benzene sulphonate; and (b) one or more detersive co-surfactants. The detersive co-surfactants are also described in more detail below but are typically selected from the group consisting of C₁₂-C₁₈ alkyl ethoxylated alcohols having an average degree of ethoxylation of from 3 to 7; C₁₂-C₁₈ alkyl ethoxylated sulphates having an average degree of ethoxylation of from 1 to 5; and mixtures thereof.

The composition comprises a spray-dried particle. The spray-dried particle is described in more detail below but typically comprises alkyl benzene sulphonate, polymeric carboxylate, and optionally silicate salt.

The composition comprises polymeric carboxylate. The polymeric carboxylate is described in more detail below.

The composition comprises bleach. Suitable bleaching agents are described in more detail below.

The composition preferably comprises from 0 wt % to 15 wt %, or from 0 wt % to 10 wt %, or from 0 wt % to 5 wt % zeolite builder. The composition may even be essentially free from zeolite builder. These levels of zeolite improve the dissolution profile of the composition. The zeolite builder is described in more detail below.

The composition preferably comprises from 0 wt % to 15 wt %, or from 0 wt % to 10 wt %, or from 0 wt % to 5 wt % phosphate builder. The composition may even be essentially free from phosphate builder. These levels of phosphate improve the environmental profile of the composition. The phosphate builder is described in more detail below.

The composition preferably comprises silicate salt. The composition may comprise from 0.1 wt % to 15 wt %, or from 0.5 wt %, or from 1 wt %, or from 2 wt %, or from 3 wt %, and preferably to 10 wt % or 8 wt % or even 6 wt % silicate salt. These levels of silicate salt improve the processability of the composition. The silicate salt is described in more detail below.

The composition may comprise chelant. The chelant is described in more detail below.

The composition may comprise any other suitable detergent adjunct ingredient. The detergent adjunct ingredients are described in more detail below.

The detergent composition typically has a bulk density of from 450 g/l to 1,000 g/l, preferred low bulk density detergent compositions have a bulk density of from 450 g/l to 650 g/l and preferred high bulk density detergent compositions have a bulk density of from 750 g/l to 900 g/l.

During the laundering process, the composition is typically contacted with water to give a wash liquor having a pH of from above 7 to less than 13, preferably from 8 to 11. This is the optimal pH to provide good cleaning whilst also ensuring a good fabric care profile.

The weight ratio of alkyl benzene sulphonate to co-polyester of dicarboxylic acids and diols present in the composition is in the range of from 20:1 to 100:1 preferably from 25:1, or from 30:1, or from 35:1, or even from 40:1 and preferably to 90:1, or to 80:1, or to 70:1, or to 60:1, or even to 50:1.

The weight ratio of detersive co-surfactant to co-polyester of dicarboxylic acids and diols present in the composition is in the range of from 5:1 to 60:1, preferably from 10:1 and preferably to 50:1, or even to 40:1.

Cellulosic polymer: The cellulosic polymer can be any polymer that is or derived from cellulose. Suitable cellulosic polymers include anionically modified celluloses, non-ionically modified celluloses, cationically modified celluloses, zwitterionically modified celluloses, and any mixture thereof. Suitable cellulosic polymers can be both non-ionically modified and anionically modified, such as a cellulose that is modified by the incorporation of both an alkyl and a carboxymethyl substituent moiety.

The cellulosic polymer is typically a cellulose or a modified cellulose. Suitable cellulosic polymers include cellulose, cellulose ethers, cellulose esters, cellulose amides and mixtures thereof. Suitable cellulosic polymers include anionically modified cellulose, nonionically modified cellulose, cationically modified cellulose, zwitterionically modified cellulose, and mixtures thereof. Suitable cellulosic polymers include methyl cellulose, carboxy methyl cellulose, ethyl cellulose, hydroxylethyl cellulose, hydroxylpropyl methyl cellulose, ester carboxy methyl cellulose, and mixtures thereof.

Other suitable cellulosic polymers include cationic cellulose and derivatives thereof. Suitable cationic cellulose is available from Amerchol Corp. (Edison, N.J., USA) in their Polymer JR™ and LR™ series of polymers. Other suitable cationic cellulose is the form of a salt of hydroxyethyl cellulose that is reacted with trimethyl ammonium substituted epoxide, such as that supplied by Amerchol Corp. under the tradename Polyquaternium 10™. Another suitable type of cationic cellulose includes the polymeric quaternary ammonium salts of hydroxyethyl cellulose reacted with lauryl dimethyl ammonium-substituted epoxide, such as that supplied by Amerchol Corp. under the tradename Polyquaternium 24™. Suitable cellulosic polymers are supplied by Amerchol Corp. under the tradename Polymer LM-200™. Other suitable cellulosic polymers include methylhydroxyethyl cellulose TYLOSE MH50™, hydroxypropylmethyl cellulose METHOCEL F4M™. Other suitable cellulosic polymers include: quaternary nitrogen-containing cellulose ethers, such as those described in more detail in U.S. Pat. No. 3,962,418; and copolymers of etherified cellulose and starch, such as those described in more detail in U.S. Pat. No. 3,958,581.

Most preferably, the cellulosic polymer is carboxy methyl cellulose, typically having the following general formula:

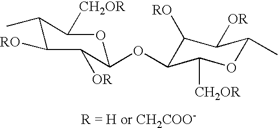

and wherein at least one R moiety is CH₂COO⁻.

Preferred cellulosic polymers are selected from the group consisting of: cellulose; carboxymethyl cellulose; methyl cellulose; ethyl cellulose; hydroxyethyl cellulose; alkyl cellulose; mixture of alkyl and carboxymethyl cellulose; and mixtures thereof. Highly preferred are carboxymethyl cellulose and/or methyl cellulose. Most preferred cellulosic polymers are carboxymethyl cellulose.

Cellulosic polymer particle: The cellulosic polymer is preferably in particulate form. The cellulosic polymer particle typically comprises from 70 wt % to 100 wt %, preferably from 75 wt %, or 80 wt %, or 85 wt %, or 90 wt %, or 95 wt %, or 96 wt %, or even 97 wt %, and preferably to 99 wt % cellulosic polymer.

The cellulosic polymer particle preferably has a particle size distribution such that preferably the weight average particle size is in the range of from 300 micrometers to 600 micrometers, and/or no more than 10 wt % of the particles have a particle size of less than 150 micrometers, and/or no more than 5 wt % of the particles have a particle size of greater than 1,180 micrometers.

Such a particle can be used to improve the water-solubility of a solid laundry detergent composition comprising a cellulosic polymer and silicate salt.

Zeolite builder: Typical zeolite builders are zeolite A, zeolite P and zeolite MAP.

Phosphate builder: A typical phosphate builder is sodium tri-polyphosphate.

Silicate salt: Any silicate salt is suitable for use in the present invention. Silicate salts include water-insoluble silicates. Silicate salts include amorphous silicates and crystalline layered silicates (e.g. SKS-6). A preferred silicate salt is sodium silicate. A preferred silicate salt is 1.6 R sodium silicate salt, although 2.0 R, 2.35 R or some other ratio silicate salt may also be used.

Co-polyester of di-carboxylic acids and diols: Suitable co-polyesters of di-carboxylic acids and diols include co-polyesters of adipic acid, phthalic acid or terephthalic acid with ethylene glycol, propylene glycol or polydiols such as polyethylene glycol or polypropylene glycol.

Preferred co-polyesters include those compounds which are obtainable by esterification of two monomer units, the first monomer being a di-carboxylic acid HOOC-Ph-COOH and the second monomer a diol HO—(CHR11-)aOH which may also be present as a polymeric diol H—(O—(CHR11-)a)bOH. In this formula, Ph is an o-, m- or p-phenylene radical which may bear from 1 to 4 substituents selected from alkyl radicals having from 1 to 22 carbon atoms, sulphonic acid groups, carboxyl groups and mixtures thereof, R11 is hydrogen, an alkyl radical having from 1 to 22 carbon atoms and mixtures thereof, a is from 2 to 6 and b is from 1 to 300. Preferably both monomer diol units —O—(CHR11-)aO— and polymer diol units —(O—(CHR11-)a)bO— are present. The molar ratio of monomer diol units to polymer diol units is preferably from 100:1 to 1:100, in particular from 10:1 to 1:10. In the polymer diol units, the degree of polymerization b is preferably in the range from 4 to 200, in particular from 12 to 140. The molecular weight or the mean molecular weight or the maximum of the molecular weight distribution of preferred soil release-capable polyesters is in the range from 250 to 100 000, in particular from 500 to 50 000. The parent acid of the Ph radical is preferably selected from terephthalic acid, isophthalic acid, phthalic acid, trimellitic acid, mellitic acid, the isomers of sulphophthalic acid, sulphoisophthalic acid and sulphoterephthalic acid, and mixtures thereof; preferably sulphoterephthalic acid. When the acid groups are not part of the ester bonds in the polymer, they are preferably present in salt form, in particular as the alkali metal or ammonium salt. Among these, particular preference is given to the sodium and potassium salts. If desired, instead of the monomer HOOC-Ph-COOH small fractions, in particular not more than 10 mol % based on the proportion of Ph as defined above, of other acids which have at least two carboxyl groups may be present in the co-polyester. These include, for example, alkylene- and alkenylenedicarboxylic acids such as malonic acid, succinic acid, fumaric acid, maleic acid, glutaric acid, adipic acid, pimelic acid, suberic acid, azelaic acid and sebacic acid. The preferred diols HO—(CHR11-)aOH include those in which R11 is hydrogen and a is from 2 to 6, and those in which a is 2 and R11 is selected from hydrogen and the alkyl radicals having from 1 to 10, in particular from 1 to 3, carbon atoms. Among the latter diols, particular preference is given to those of the formula HO—CH₂—CHR11-OH in which R11 is as defined above. The examples of diol components are ethylene glycol, 1,2-propylene glycol, 1,3-propylene glycol, 1,4-butanediol, 1,5-pentanediol, 1,6-hexanediol, 1,8-octanediol, 1,2-decanediol, 1,2-dodecanediol and neopentyl glycol. Among the polymeric diols, particular preference is given to polyethylene glycol having a mean molar mass in the range of from 1000 da to 6000 da.

If desired, the polyesters having the composition as described above may also be end group-capped, in which case useful end groups are alkyl groups having from 1 to 22 carbon atoms and esters of mono-carboxylic acids. The parent acids of the end groups bonded by means of ester bonds may be alkyl-, alkenyl- and arylmonocarboxylic acids having from 5 to 32 carbon atoms, in particular from 5 to 18 carbon atoms. These include valeric acid, caproic acid, enanthic acid, caprylic acid, pelargonic acid, capric acid, undecanoic acid, undecenoic acid, lauric acid, lauroleic acid, tridecanoic acid, myristic acid, myristoleic acid, pentadecanoic acid, palmitic acid, stearic acid, petroselic acid, petroselaidic acid, oleic acid, linoleic acid, linolaidic acid, linolenic acid, eleostearic acid, arachic acid, gadoleic acid, arachidonic acid, behenic acid, erucic acid, brassidic acid, clupanodonic acid, lignoceric acid, cerotic acid, melissic acid, benzoic acid which may bear from 1 to 5 substituents having a total of up to 25 carbon atoms, in particular from 1 to 12 carbon atoms, for example tert-butylbenzoic acid. The parent acids of the end groups may also be hydroxymonocarboxylic acids, having from 5 to 22 carbon atoms, which include, for example, hydroxyvaleric acid, hydroxycaproic acid, ricinoleic acid, their hydrogenation product hydroxystearic acid, and also o-, m- and p-hydroxybenzoic acid. The hydroxymonocarboxylic acids may in turn be joined together by means of their hydroxyl group and their carboxyl group and thus be present more than once in one end group. The number of hydroxymonocarboxylic acid units per end group, i.e. their degree of oligomerization, is preferably in the range from 1 to 50, in particular from 1 to 10. In a preferred embodiment of the invention, polymers composed of ethylene terephthalate and polyethylene oxide terephthalate in which the polyethylene glycol units have molar masses of from 750 to 5000 and the molar ratio of ethylene terephthalate to polyethylene oxide terephthalate is from 50:50 to 90:10 are used in combination with the cellulose derivatives.

The co-polyesters are preferably water-soluble, the term “water-soluble” meaning a solubility of at least 0.01 g, preferably at least 0.1 g, of the polymer per liter of water at room temperature and pH 8. However, co-polyesters used with preference have a solubility of at least 1 g per liter, in particular at least 10 g per liter, under these conditions.

Preferably, the co-polyester has the following general formula:

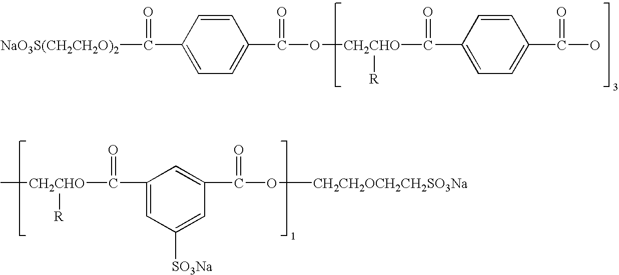

wherein R is hydrogen.
Detersive surfactant: The composition comprises from 0.1 wt % to 20 wt % detersive surfactant. The surfactant comprises alkyl benzene sulphonate and one or more detersive co-surfactants. The surfactant preferably comprises C₁₀-C₁₃ alkyl benzene sulphonate and one or more co-surfactants. The co-surfactants preferably are selected from the group consisting of C₁₂-C₁₈ alkyl ethoxylated alcohols having an average degree of ethoxylation of from 3 to 7; C₁₂-C₁₈ alkyl ethoxylated sulphates having an average degree of ethoxylation of from 1 to 5; and mixtures thereof. However, other surfactant systems may be suitable for use in the present invention.

The composition comprises a detersive surfactant. Suitable detersive surfactants include anionic detersive surfactants, nonionic detersive surfactants, cationic detersive surfactants, zwitterionic detersive surfactants, amphoteric detersive surfactants and mixtures thereof.

Suitable anionic detersive surfactants include: alkyl sulphates; alkyl sulphonates; alkyl phosphates; alkyl phosphonates; alkyl carboxylates; and mixtures thereof. The anionic surfactant can be selected from the group consisting of: C₁₀-C₁₈ alkyl benzene sulphonates (LAS) preferably C₁₀-C₁₃ alkyl benzene sulphonates; C₁₀-C₂₀ primary, branched chain, linear-chain and random-chain alkyl sulphates (AS), typically having the following formula:

CH₃(CH₂)xCH₂—OSO₃⁻M⁺

wherein, M is hydrogen or a cation which provides charge neutrality, preferred cations are sodium and ammonium cations, wherein x is an integer of at least 7, preferably at least 9; C₁₀-C₁₈ secondary (2,3) alkyl sulphates, typically having the following formulae:

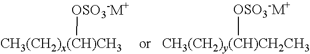

wherein, M is hydrogen or a cation which provides charge neutrality, preferred cations include sodium and ammonium cations, wherein x is an integer of at least 7, preferably at least 9, y is an integer of at least 8, preferably at least 9; C₁₀-C₁₈ alkyl alkoxy carboxylates; mid-chain branched alkyl sulphates as described in more detail in U.S. Pat. No. 6,020,303 and U.S. Pat. No. 6,060,443; modified alkylbenzene sulphonate (MLAS) as described in more detail in WO 99/05243, WO 99/05242, WO 99/05244, WO 99/05082, WO 99/05084, WO 99/05241, WO 99/07656, WO 00/23549, and WO 00/23548; methyl ester sulphonate (MES); alpha-olefin sulphonate (AOS) and mixtures thereof.

Preferred anionic detersive surfactants include: linear or branched, substituted or unsubstituted alkyl benzene sulphonate detersive surfactants, preferably linear C₈-C₁₈ alkyl benzene sulphonate detersive surfactants; linear or branched, substituted or unsubstituted alkyl benzene sulphate detersive surfactants; linear or branched, substituted or unsubstituted alkyl sulphate detersive surfactants, including linear C₈-C₁₈ alkyl sulphate detersive surfactants, C₁-C₃ alkyl branched C₈-C₁₈ alkyl sulphate detersive surfactants, linear or branched alkoxylated C₈-C₁₈ alkyl sulphate detersive surfactants and mixtures thereof; linear or branched, substituted or unsubstituted alkyl sulphonate detersive surfactants; and mixtures thereof.

Preferred alkoxylated alkyl sulphate detersive surfactants are linear or branched, substituted or unsubstituted C₈₋₁₈ alkyl alkoxylated sulphate detersive surfactants having an average degree of alkoxylation of from 1 to 30, preferably from 1 to 10. Preferably, the alkoxylated alkyl sulphate detersive surfactant is a linear or branched, substituted or unsubstituted C₈₋₁₈ alkyl ethoxylated sulphate having an average degree of ethoxylation of from 1 to 10. Most preferably, the alkoxylated alkyl sulphate detersive surfactant is a linear unsubstituted C₈₋₁₈ alkyl ethoxylated sulphate having an average degree of ethoxylation of from 3 to 7.

Preferred anionic detersive surfactants are selected from the group consisting of: linear or branched, substituted or unsubstituted, C₁₂₋₁₈ alkyl sulphates; linear or branched, substituted or unsubstituted, C₁₀-C₁₃ alkylbenzene sulphonates, preferably linear C₁₀-C₁₃ alkylbenzene sulphonates; and mixtures thereof. Highly preferred are linear C₁₀-C₁₃ alkylbenzene sulphonates. Highly preferred are linear C₁₀-C₁₃ alkylbenzene sulphonates that are obtainable, preferably obtained, by sulphonating commercially available linear alkyl benzenes (LAB); suitable LAB include low 2-phenyl LAB, such as those supplied by Sasol under the tradename Isochem® or those supplied by Petresa under the tradename Petrelab®, other suitable LAB include high 2-phenyl LAB, such as those supplied by Sasol under the tradename Hyblene®. A suitable anionic detersive surfactant is alkyl benzene sulphonate that is obtained by DETAL catalyzed process, although other synthesis routes, such as HF, may also be suitable.

Suitable cationic detersive surfactants include: alkyl pyridinium compounds; alkyl quaternary ammonium compounds; alkyl quaternary phosphonium compounds; alkyl ternary sulphonium compounds; and mixtures thereof. The cationic detersive surfactant can be selected from the group consisting of: alkoxylate quaternary ammonium (AQA) surfactants as described in more detail in U.S. Pat. No. 6,136,769; dimethyl hydroxyethyl quaternary ammonium as described in more detail in U.S. Pat. No. 6,004,922; polyamine cationic surfactants as described in more detail in WO 98/35002, WO 98/35003, WO 98/35004, WO 98/35005, and WO 98/35006; cationic ester surfactants as described in more detail in U.S. Pat. No. 4,228,042, U.S. Pat. No. 4,239,660, U.S. Pat. No. 4,260,529 and U.S. Pat. No. 6,022,844; amino surfactants as described in more detail in U.S. Pat. No. 6,221,825 and WO 00/47708, specifically amido propyldimethyl amine; and mixtures thereof. Preferred cationic detersive surfactants are quaternary ammonium compounds having the general formula:

(R)(R₁)(R₂)(R₃)N⁺X⁻

wherein, R is a linear or branched, substituted or unsubstituted C₆₋₁₈ alkyl or alkenyl moiety, R₁ and R₂ are independently selected from methyl or ethyl moieties, R₃ is a hydroxyl, hydroxymethyl or a hydroxyethyl moiety, X is an anion which provides charge neutrality, preferred anions include halides (such as chloride), sulphate and sulphonate. Preferred cationic detersive surfactants are mono-C₆₋₁₈ alkyl mono-hydroxyethyl di-methyl quaternary ammonium chlorides. Highly preferred cationic detersive surfactants are mono-C₈₋₁₀ alkyl mono-hydroxyethyl di-methyl quaternary ammonium chloride, mono-C₁₀-C₁₂ alkyl mono-hydroxyethyl di-methyl quaternary ammonium chloride and mono-C₁₀ alkyl mono-hydroxyethyl di-methyl quaternary ammonium chloride.

Suitable non-ionic detersive surfactant can be selected from the group consisting of: C₈-C₁₈ alkyl ethoxylates, such as, NEODOL® non-ionic surfactants from Shell; C₆-C₁₂ alkyl phenol alkoxylates wherein the alkoxylate units are ethyleneoxy units, propyleneoxy units or a mixture thereof; C₁₂-C₁₈ alcohol and C₆-C₁₂ alkyl phenol condensates with ethylene oxide/propylene oxide block polymers such as Pluronic® from BASF; C₁₄-C₂₂ mid-chain branched alcohols, BA, as described in more detail in U.S. Pat. No. 6,150,322; C₁₄-C₂₂ mid-chain branched alkyl alkoxylates, BAEx, wherein x=from 1 to 30, as described in more detail in U.S. Pat. No. 6,153,577, U.S. Pat. No. 6,020,303 and U.S. Pat. No. 6,093,856; alkylpolysaccharides as described in more detail in U.S. Pat. No. 4,565,647, specifically alkylpolyglycosides as described in more detail in U.S. Pat. No. 4,483,780 and U.S. Pat. No. 4,483,779; polyhydroxy fatty acid amides as described in more detail in U.S. Pat. No. 5,332,528, WO 92/06162, WO 93/19146, WO 93/19038, and WO 94/09099; ether capped poly(oxyalkylated) alcohol surfactants as described in more detail in U.S. Pat. No. 6,482,994 and WO 01/42408; and mixtures thereof.

The non-ionic detersive surfactant could be an alkyl polyglucoside and/or an alkyl alkoxylated alcohol. Preferably the non-ionic detersive surfactant is a linear or branched, substituted or unsubstituted C₈₋₁₈ alkyl ethoxylated alcohol having an average degree of ethoxylation of from 1 to 10, more preferably from 3 to 7.

Spray-dried particle: The composition comprises a spray-dried particle. The spray-dried particle is typically formed by mixing various detergent ingredients, typically to form a slurry, and then spraying the slurry in a spray-drying tower to form spray-dried particles. The spray-dried particle comprises alkyl benzene sulphonate, polymeric carboxylate, and optionally, if present, silicate salt, preferably sodium silicate.

The spray-dried particle has a bulk density in the range of from 300 g/l to 5001 g/, preferably 350 g/l to 450 g/l. The spray-dried particle preferably has a particle size distribution such that preferably the weight average particle size is in the range of from 300 micrometers to 450 micrometers, and/or no more than 15 wt % of the particles have a particle size of less than 150 micrometers, and/or no more than 5 wt % of the particles have a particle size of greater than 1,180 micrometers.

Polymeric carboxylate: The composition comprises polymeric carboxylate. It may be preferred for the composition to comprise at least 1%, or at least 2%, or at least 3%, or at least 4%, or even at least 5%, by weight of the composition, of polymeric carboxylate. The polymeric carboxylate can sequester free calcium ions in the wash liquor. The carboxylate polymers can also act as soil dispersants and can provide an improved particulate stain removal cleaning benefit. Preferred polymeric carboxylates include: polyacrylates, preferably having a weight average molecular weight of from 1,000 Da to 20,000 Da; co-polymers of maleic acid and acrylic acid, preferably having a molar ratio of maleic acid monomers to acrylic acid monomers of from 1:1 to 1:10 and a weight average molecular weight of from 10,000 Da to 200,000 Da, or preferably having a molar ratio of maleic acid monomers to acrylic acid monomers of from 0.3:1 to 3:1 and a weight average molecular weight of from 1,000 Da to 50,000 Da.

Chelant: Suitable chelants include diethylene triamine pentaacetate, diethylene triamine penta(methyl phosphonic acid), ethylene diamine-N′N′-disuccinic acid, ethylene diamine tetraacetate, ethylene diamine tetra(methylene phosphonic acid) and hydroxyethane di(methylene phosphonic acid). A preferred chelant is ethylene diamine-N′N′-disuccinic acid.

Bleach: Suitable bleach includes percarbonate and/or perborate, preferably in combination with a bleach activator such as tetraacetyl ethylene diamine, oxybenzene sulphonate bleach activators such as nonanoyl oxybenzene sulphonate, caprolactam bleach activators, imide bleach activators such as N-nonanoyl-N-methyl acetamide, preformed peracids such as N,N-pthaloylamino peroxycaproic acid, nonylamido peroxyadipic acid or dibenzoyl peroxide. It may also be preferred that the composition comprises a bleach catalyst, such as a coordinated transition metal ligand bleach catalyst, or an isoquinolinium based, preferably a zwitterionically modified isoquinolinium based bleach catalyst.

Detergent adjunct ingredients: The composition typically comprises adjunct detergent ingredients. Suitable adjunct detergent ingredients include: carbonate salt such as sodium carbonate and/or sodium bicarbonate; enzymes such as amylases, carbohydrases, cellulases, laccases, lipases, oxidases, peroxidases, proteases, pectate lyases and mannanases; suds suppressing systems such as silicone based suds suppressors; brighteners; hueing agents; photobleach; filler salts; fabric-softening agents such as clay, silicone and/or quaternary ammonium compounds; flocculants such as polyethylene oxide; dye transfer inhibitors such as polyvinylpyrrolidone, poly 4-vinylpyridine N-oxide and/or co-polymer of vinylpyrrolidone and vinylimidazole; fabric integrity components such as oligomers produced by the condensation of imidazole and epichlorhydrin; soil dispersants and soil anti-redeposition aids such as alkoxylated polyamines and ethoxylated ethyleneimine polymers; anti-redeposition components such as polyesters; perfumes such as perfume microcapsules; soap rings; aesthetic particles; and dyes.

### EXAMPLES

The following are examples of solid laundry detergent compositions in accordance with the present invention:

| | A (wt %) | | B (wt %) | | C (wt %) | | D (wt %) | |
|---|---|---|---|---|---|---|---|---|
| Spray-dried particle | | | | | | | | |
| C₁₀₋₁₃ alkyl benzene sulphonate | 7.5 | | 6.0 | | 9.0 | | 12.5 | |
| Polymeric carboxylate | 5.0 | | 1.5 | | 2.5 | | 2.5 | |
| 1.6R Sodium silicate | 0.0 | | 3.0 | | 4.5 | | 2.5 | |
| Ethylene diamine-N′N′-disuccinic | 0.2 | | 0.3 | | 0.3 | | 0.2 | |
| acid | | | | | | | | |
| Magnesium sulphate | 0.7 | | 0.7 | | 0.7 | | 0.7 | |
| Sodium carbonate | 17.0 | | 12.5 | | 13.0 | | 13.0 | |
| Sodium sulphate | 14.0 | | 12.0 | | 17.0 | | 11.0 | |
| Sodium toluene sulphonate | 0.3 | | 0.3 | | 0.3 | | 0.3 | |
| Cellulosic polymer particle | | | | | | | | |
| Carboxymethyl cellulose | 1.5 | | 3.0 | | 1.5 | | 1.0 | |
| Other dry-added materials | | | | | | | | |
| Sodium percarbonate | 0.0 | | 20.0 | | 19.0 | | 18.0 | |
| Enzymes (amylase, protease, | 1.0 | | 1.0 | | 1.0 | | 1.0 | |
| celllulase, lipase) | | | | | | | | |
| Co-polyester of a dicarboxylic | 0.1 | | 0.2 | | 0.2 | | 0.3 | |
| acid and a diol | | | | | | | | |
| C₈₋₁₈ alkyl ethoxylated sulphate | 4.0 | | 2.0 | | 2.0 | | 2.0 | |
| having an average degree of | | | | | | | | |
| sulphonate of 3 | | | | | | | | |
| Tetraacetyl ethylene diamine | 0.0 | | 2.5 | | 2.5 | | 4.0 | |
| Citric acid | 2.0 | | 3.0 | | 2.0 | | 0.0 | |
| Sodium carbonate | 14.0 | | 12.0 | | 10.0 | | 5.0 | |
| Liquid spray-on ingredients | | | | | | | | |
| Perfume | 0.3 | | 0.3 | | 0.3 | | 0.3 | |
| C₈₋₁₈ alkyl ethoxylated alcohol | 0.5 | | 1.0 | | 0.9 | | 3.0 | |
| having an average degree of | | | | | | | | |
| ethoxylation of from 3 to 7 | | | | | | | | |
| Other material | | | | | | | | |
| Miscellaneous, water and filler | To 100 | wt % | to 100 | wt % | to 100 | wt % | to 100 | wt % |
| (including dry-added sodium sulphate) | | | | | | | | |

The dimensions and values disclosed herein are not to be understood as being strictly limited to the exact numerical values recited. Instead, unless otherwise specified, each such dimension is intended to mean both the recited value and a functionally equivalent range surrounding that value. For example, a dimension disclosed as “40 mm” is intended to mean “about 40 mm”.

Every document cited herein, including any cross referenced or related patent or application, is hereby incorporated herein by reference in its entirety unless expressly excluded or otherwise limited. The citation of any document is not an admission that it is prior art with respect to any invention disclosed or claimed herein or that it alone, or in any combination with any other reference or references, teaches, suggests or discloses any such invention. Further, to the extent that any meaning or definition of a term in this document conflicts with any meaning or definition of the same term in a document incorporated by reference, the meaning or definition assigned to that term in this document shall govern.

While particular embodiments of the present invention have been illustrated and described, it would be obvious to those skilled in the art that various other changes and modifications can be made without departing from the spirit and scope of the invention. It is therefore intended to cover in the appended claims all such changes and modifications that are within the scope of this invention.

What is claimed is:

1. A solid laundry detergent composition comprising:
(a) 0.1 wt % to 20 wt % detersive surfactant, wherein the surfactant comprises:
(i) alkyl benzene sulphonate; and
(ii) one or more detersive co-surfactants;
(b) a co-polyester of dicarboxylic acids and diols;
(c) polymeric carboxylate;
(d) bleach; and
(e) cellulosic polymer;
wherein the composition comprises a spray-dried particle comprising at least some of the alkyl benzene sulphonate and at least some of the polymeric carboxylate, wherein the weight ratio of alkyl benzene sulphonate to co-polyester of dicarboxylic acids and diols present in the composition is in the range of from 20:1 to 100:1, and wherein the weight ratio of detersive co-surfactant to co-polyesters of dicarboxylic acids and diols present in the composition is in the range of from 5:1 to 60:1.

2. A composition according to claim 1, wherein the co-polyester of dicarboxylic acids and diols, comprises sulphoterephtalic acid monomer and a glycol monomer.

3. A composition according to claim 1, wherein the cellulosic polymer is selected from the group consisting of: cellulose; carboxymethyl cellulose; methyl cellulose; ethyl cellulose; hydroxyethyl cellulose; alkyl cellulose; mixture of alkyl and carboxymethyl cellulose; and mixtures thereof.

4. A composition according to claim 1, wherein the composition comprises
(a) from 0 wt % to 15 wt % zeolite builder
(b) from 0 wt % to 15 wt % phosphate builder; and
(c) optionally, from 1 wt % to 15 wt % silicate salt.

5. A composition according to claim 1, wherein the weight ratio of alkyl benzene sulphonate to co-polyester of dicarboxylic acids and diols present in the composition is in the range of from 30:1 to 60:1.

6. A composition according to claim 1, wherein the weight ratio of detersive co-surfactant to co-polyester of dicarboxylic acids and diols present in the composition is in the range of from 10:1 to 40:1.

7. A composition according to claim 1, wherein the co-surfactants are selected from the group consisting of C₁₂-C₁₈ alkyl ethoxylated alcohols having an average degree of ethoxylation of from 3 to 7; C₁₂-C₁₈ alkyl ethoxylated sulphates having an average degree of ethoxylation of from 1 to 5; and mixtures thereof.

8. A composition according to claim 1, wherein the composition comprises silicate salt.

9. A composition according to claim 1, wherein the composition comprises chelant and bleach.
